(19) United States
(12) Patent Application Publication
(10) Pub. No.: US 2021/0213400 A1
(43) Pub. Date: Jul. 15, 2021

(54) GAS-LIQUID MIXING DEVICE

(71) Applicant: MTEC CO., LTD., Aichi (JP)

(72) Inventor: Fumio ASANO, Aichi (JP)

(73) Assignee: MTEC CO., LTD., Aichi (JP)

(21) Appl. No.: 16/743,509

(22) Filed: Jan. 15, 2020

(51) Int. Cl. B01F 5/00; B01F 3/04; B01F 5/04

(52) U.S. Cl. CPC B01F 5/0062; B01F 3/04503; B01F 5/0428; B01F 2005/0045; B01F 2005/0014; B01F 2005/0017; B01F 5/048

(57) ABSTRACT

The present device is a gas-liquid mixing device having a venturi structure A in which a throttle portion and a conical portion are provided in a main passage through which a liquid passes, including: a gas mixing passage for taking in gas from a tangential direction with respect to the main passage having a circular cross section; and a protruding portion provided on a downstream side of the gas mixing passage of an inner wall forming the main passage and extending in a central axis direction of the main passage. It is preferable that the protruding portion is provided on an inner wall forming the conical portion, and is formed such that a protruding height from the inner wall increases toward the downstream side.

### BACKGROUND OF THE INVENTION

### (1) Field of the Invention

The present invention relates to a gas-liquid mixing device, and more particularly, to a gas-liquid mixing device that generates fine bubbles.

### (2) Description of Related Art

Fine bubbles have characteristics such as crushing phenomenon that can increase the amount of dissolved oxygen with high efficiency by increasing a gas-liquid interface to decompose chemical substances, and generation of negative ions, and are already used in various fields such as aquaculture, purification, and cleaning. A gas-liquid mixing device having a venturi structure that generates uniform and fine bubbles is widely used.

As the gas-liquid mixing device having the venturi structure that generates the fine bubbles, a technology has been proposed in which a throttle portion of a main passage in which the inside of the main passage is in a negative pressure state is formed by connecting a plurality of members, a fine groove-shaped gas introduction point is provided on each joint surface to mix fine gas, and a contact area between the gas and the flowing liquid is increased by forming a crushing groove on a downstream side of the gas introduction portion, and bubbles are crushed by colliding with water flow to generate fine bubbles (Japanese Unexamined Patent Publication No. 2008-23513).

In addition, a technology has been proposed in which a helical propeller-type blade row is provided at the center of the main passage, and a helical blade row rotating in a direction opposite to the blade row of the main passage center is provided in an outer ring of the helical passage, at downstream of the throttle portion of the main passage in which gas and liquid are mixed, and a liquid flow in a liquid main passage is divided into two layers, swirled, and crushed by colliding to generate fine bubbles (Japanese Unexamined Patent Publication No. 2007-21343).

The amount of gas that can be mixed in a venturi structure is governed by the amount of change in pressure of a main passage of a flowing liquid and pressure of a throttle portion. Therefore, the amount of gas that can be mixed is determined by a pressure difference. Moreover, since the gas just mixed does not become fine bubbles, various techniques for generating the fine bubbles have been proposed.

In Japanese Unexamined Patent Publication No. 2008-23513, an air introduction nozzle formed in a plurality of stages is connected to a nozzle member, and gas to be sucked into the liquid flowing through the flowing water passage is mixed little by little. By shallowly carving grooves for air suction, and further, providing grooves for crushing bubbles connected to the grooves for air suction in a flow direction, a contact area between the gas and the flowing liquid is increased and fine bubbles are generated by colliding with the water flow. However, since water flow energy that is sheared in the crushing grooves is before a swirling flow is accelerated, and the amount of gas that can be sucked as the fine bubbles by one joint surface that the groove is carved shallowly is limited, it is necessary to provide a plurality of members to mix a required amount of gas, and the number of parts increases.

Further, in Japanese Unexamined Patent Publication No. 2007-21343, the liquid is suppressed by a blade row and swirled by providing the blade row having different rotation directions in a cylindrical casing. For this reason, a pressure loss at which a pressurized liquid passes through the blade row increases, and the amount of air that can be mixed decreases. Fine bubbles cannot be generated with a small flow rate, and the production of a propeller-type blade row is complicated and expensive.

### SUMMARY OF THE INVENTION

An embodiment of the present invention is to solve the above-mentioned problems, and an object thereof is to provide a gas-liquid mixing device that can be manufactured at low cost and can generate uniform and fine bubbles.

In order to solve the above problems, in one aspect of the present embodiments, a gas-liquid mixing device having a venturi structure in which a throttle portion and a conical portion being continuous with a downstream side of the throttle portion and increasing in diameter toward the downstream side are provided in a main passage through which a liquid passes, the gas-liquid mixing device including: a gas mixing passage for taking in gas from a tangential direction with respect to the main passage having a circular cross section; and a protruding portion provided on a downstream side of the gas mixing passage of an inner wall forming the main passage and extending in a central axis direction of the main passage.

In a further aspect, the protruding portion may be provided on an inner wall forming the conical portion, and may be formed such that a protruding height from the inner wall increases toward the downstream side.

In a further aspect, the protruding portion may be provided on a downstream side of the conical portion of the inner wall forming the main passage.

In a further aspect, the main passage may be formed across a first member and a second member joined to the first member, the gas mixing passage may be formed in a groove shape on a joint surface side of the first member with respect to the second member, and an inner diameter of the main passage of the second member may be larger than an inner diameter of the main passage of the first member on an upstream side, in the joint surface of the first member and the second member.

In a further aspect, further may include a long-hole shaped discharge port along a circumference of a central axis of the main passage.

According to the gas-liquid mixing device of the present embodiment, the gas mixing passage for taking in gas from the tangential direction with respect to the main passage having a circular cross section, and the protruding portion provided on the downstream side of the gas mixing passage of the inner wall forming the main passage and extending in the central axis direction of the main passage are provided. Thereby, in the component structure based on the venturi structure, the liquid flowing through the main passage can be turned into a swirling flow in which the gas and liquid are mixed by mixing the gas from the tangential direction with respect to the main passage. The main swirling flow in which the gas and liquid are mixed is accelerated by centrifugal force along the inner wall of the conical portion as it advances in the flow direction. The accelerated main swirling flow collides with the protruding portion to cause bubble crushing, and the sub swirling flow is generated from the main swirling flow and collided with the main swirling flow, whereby the crushing of the bubbles is perforated more intensely. As a result, the uniform and fine bubbles can be generated.

In addition, when the protruding portion is provided on the inner wall forming the conical portion and is formed so that the protruding height from the inner wall increases toward the downstream side, the main swirling flow can be received downstream without resistance and accelerated effectively by setting the protruding portion low on the upstream side of the conical portion. Furthermore, the crushing of the bubbles due to the collision is effectively performed by setting the protruding portion high on the downstream side of the conical portion.

Further, when the protruding portion is provided on the downstream side of the conical portion of the inner wall forming the main passage, the main swirling flow sufficiently accelerated by the conical portion collides with the protruding portion, thereby causing the crushing of the bubbles effectively.

In addition, the main passage is formed across the first member and the second member, the gas mixing passage is formed in a groove shape on the joint surface side of the first member, and in the joint surface of the first member and the second member, when the inner diameter of the main passage of the second member is larger than the inner diameter of the main passage of the first member on the upstream side, a gas mixing passage connected to a tangential position of the maximum diameter of the circular main passage on the end surface of the second member that is larger than the main passage on the end surface of the first member can be formed.

Thus, if the position of the mixed gas is the tangential position of the maximum diameter that swirls in the main passage, the energy of the swirling flow becomes large, and the fine bubbles using the energy of the swirling flow can be generated uniformly.

Furthermore, the gas can be mixed from the direction most suitable for the swirling direction into the flow region in which the liquid is difficult to flow when the liquid flowing through the main passage is released from the throttle portion. For this reason, when sucked into the liquid flowing through the main passage, the gas can be mixed from the direction in which the traveling direction of the liquid and the tangential direction with respect to the main passage are combined, and the loss of liquid energy generated when the liquid is mixed with the flowing liquid can be reduced.

Further, in the case of providing a long-hole shaped discharge port along the circumference of the central axis of the main passage, a central flow, which is a flow around the central axis of the main passage and does not become the swirling flow, is collided with the swirling flow accelerated along the inner wall of the conical portion, thereby making it possible to discharge the gas-liquid of finer and uniform bubbles from the discharge port.

### BRIEF DESCRIPTION OF THE DRAWINGS

The present invention will be further described in the following detailed description with reference to the drawings referred to, with reference to non-limiting examples of embodiments according to the present invention, and like reference numerals designate like parts throughout the several figures of the drawings.

FIG. 1 is a longitudinal sectional view of a gas-liquid mixing device according to an embodiment;

FIG. 2 is an enlarged cross-sectional view taken along line in FIG. 1;

FIG. 3 is an enlarged cross-sectional view taken along line III-III in FIG. 1;

FIG. 4 is an enlarged view of a main part of FIG. 1;

FIG. 5 is a longitudinal sectional view of a second member constituting the gas-liquid mixing device;

FIG. 6 is an enlarged sectional view taken along line VI-VI in FIG. 1;

FIG. 7 is an explanatory diagram for explaining a protruding portion according another embodiment;

FIG. 8 is an explanatory diagram for explaining a protruding portion according to still another embodiment;

FIG. 9 is an enlarged view taken along an arrow IX in FIG. 1;

FIG. 10 is a perspective view in which a part on a downstream end side of the gas-liquid mixing device is broken; and

FIGS. 11(a) and 11(b) are explanatory diagrams for explaining another form of the gas-liquid mixing device, wherein 11(a) shows a longitudinal section of the gas-liquid mixing device, and 11(b) shows a section taken along line b-b.

### DETAILED DESCRIPTION OF PREFERRED EMBODIMENTS

The items shown here are exemplary and illustrative of the embodiments of the present invention, and are provided for the purpose of providing What is believed to be the most effective and easy-to-understand description of the principles and conceptual features of the present invention. In this respect, it is not intended to show the structural details of the present invention beyond the extent that is necessary for a fundamental understanding of the present invention, and the description in conjunction with the drawings will make apparent to those skilled in the art how some forms of the present invention may be embodied in practice.

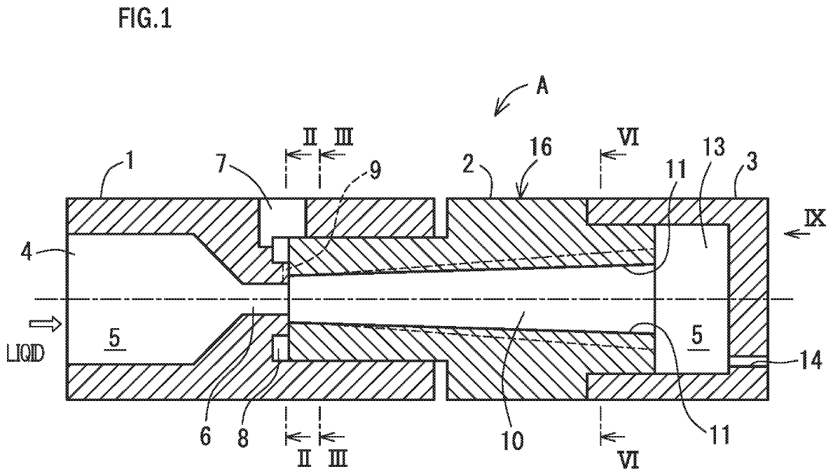

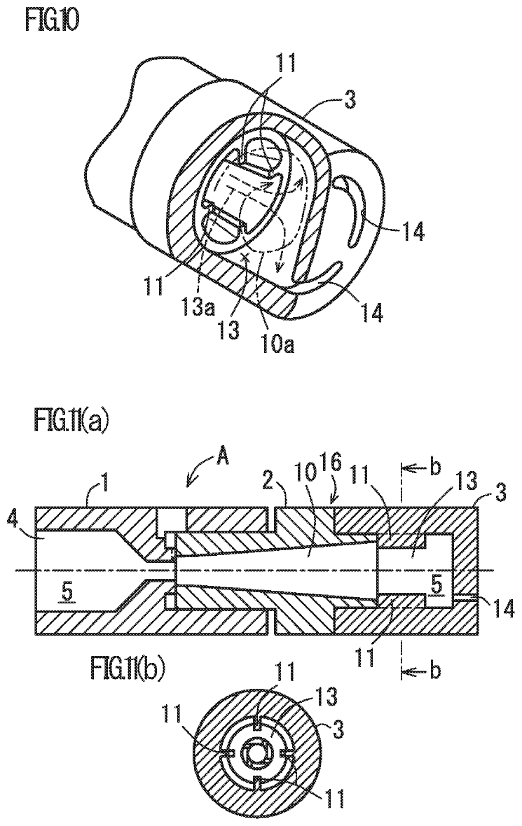

A gas-liquid mixing device according to the present embodiment, that is, a gas-liquid mixing device A having a venturi structure in which a throttle portion (6) and a conical portion (10) being continuous with a downstream side of the throttle portion and increasing in diameter toward the downstream side are provided in a main passage (5) through which a liquid passes, includes a gas mixing passage (9) for taking in gas from a tangential direction with respect to the main passage (5) having a circular cross section and a protruding portion (11) provided on a downstream side of the gas mixing passage (9) of an inner wall firming the main passage (5) and extending in a central axis direction of the main passage (5) (see, for example, FIGS. 1 and 11). Accordingly, a swirling flow (6a) is generated in a liquid flowing through the main passage (5) by mixed gas (9a) mixed from the gas mixing passage (9) (see, for example, FIG. 2). Then, as the swirling flow (6a) advances in a flow direction, a sub swirling flow (11a) is generated by a main swirling flow (10a) accelerated by a centrifugal force along the inner wall of the conical portion (10) and provision of the protruding portion (11) (see, for example, FIG. 6).

The shape, size, arrangement location, number, etc., of the gas mixing passage (9) are appropriately selected according to a liquid flow rate and the like. In addition, the shape, size, arrangement location, number, etc., of the protruding portion (11) are appropriately selected according to the liquid flow rate and the like.

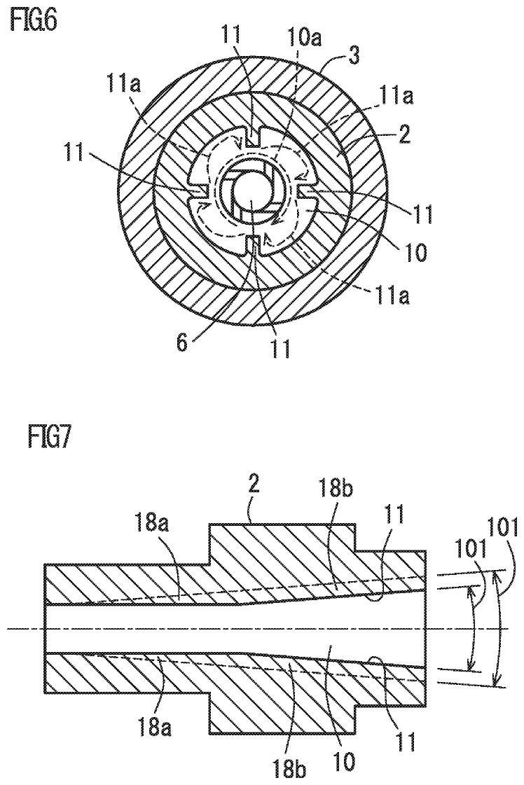

As the gas-liquid mixing device according to the present embodiment, the protruding portion (11) may be provided on the inner wall forming the conical portion (10) and may be formed such that a protruding height from the inner wall increases toward the downstream side (see, for example, FIGS. 5 and 7).

In the case of the above-described form, for example, the protruding portion (11) can be formed so that the protruding height from the inner wall of the conical portion (10) gradually increases toward the downstream side in a longitudinal direction (see, for example, FIG. 5). Further, for example, the protruding portion (11) can include a gradually changing portion (18a) in which the protruding height from the inner wall of the conical portion (10) gradually increases toward the downstream side, and a constant height portion (18b) being continuous with a downstream side of the gradually changing portion (18a) and having the same protruding height (see, for example, FIG. 7).

As the gas-liquid mixing device according to the present embodiment, for example, the protruding portion (11) is provided on the downstream side of the conical portion (10) of the inner wall forming the main passage (5) (see, for example, FIG. 11).

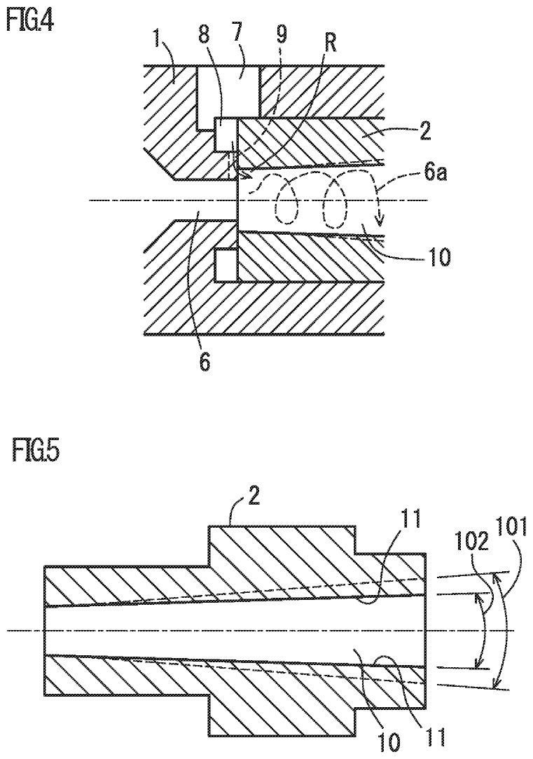

As the gas-liquid mixing device according to the present embodiment, for example, the main passage (5) is formed across a first member (1) and a second member (2) joined to the first member (1), the gas mixing passage (9) is formed in a groove shape on a joint surface side of the first member (1) with respect to the second member (2), and in the joint surface of the first member (1) and the second member (2), an inner diameter of the main passage (5) of the second member (2) is larger than the inner diameter of the main passage (5) of the first member (1) on an upstream side (see, for example, FIG. 4). Thereby, the gas from the gas mixing passage (9) can be mixed into a tangential position of the main passage (5) of the second member (2), and can also proceed in a liquid flow direction.

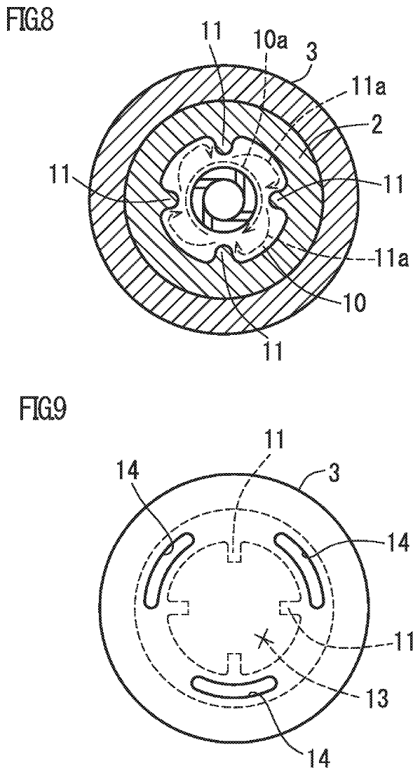

As the gas-liquid mixing device according to the present embodiment, for example, a long-hole shaped discharge port (14) can be provided along a circumference of a central axis of the main passage (5) (see, for example, FIGS. 9 and 10). Thereby, a flow (13a), which is a flow around the central axis of the main passage (5) and does not become a swirling flow, can be collided with an accelerated swirling flow (10a). Note that the size, number, arrangement location, etc., of the discharge port (14) are appropriately selected according to a discharge amount and the like.

Note that the reference numerals in parentheses of each configuration described in the above-described embodiment indicate a correspondence relationship with a specific configuration described in Examples described later.

### EXAMPLE

Hereinafter, the present invention will be specifically described by an example with reference to the drawings.

As shown in FIG. 1, a gas-liquid mixing device A according to the present example includes a main body 16 in which a main passage 5 through which a liquid passes is formed. The main body 16 includes a first member 1, a second member 2, and a third member 3 connected on the same axis. Each of the first to third members 1 to 3 is formed in a cylindrical shape from a material such as metal or resin. The first member 1 is joined to one shaft end side of the second member 2 by screwing or the like. The third member 3 is joined to the other shaft end side of the second member 2 by screwing or the like. Further, the main passage 5 is provided with a throttle portion 6 and a conical portion 10 that is continuous with a downstream side of the throttle portion 6 and has a diameter that increases toward the downstream side. Therefore, the gas-liquid mixing device A has a venturi structure.

The first member 1 is formed with a main passage inlet 4 and the throttle portion 6 that is continuous with a downstream side of the main passage inlet 4. Further, the first member 1 is formed with a gas inlet 7, a gas suction chamber 8, and a gas mixing passage 9 for mixing gas into the main passage 5 (specifically, a connecting portion of the throttle portion 6 and the conical portion 10). The gas mixing passage 9 is connected in a tangential direction on a circumference of a central axis of the main passage 5 so as to mix gas from the tangential direction with respect to the main passage 5.

In the first member 1, a cross-sectional area of the throttle portion 6 is made smaller than the cross-sectional area of the main passage inlet 4. The liquid flowing from the main passage inlet 4 passes through the throttle portion 6. At this time, due to the venturi structure, the liquid inside the throttle portion 6 flows at a high speed and enters a negative pressure state. The gas mixing passage 9 is firmed at a downstream side of the throttle portion 6 in the negative pressure state and when the liquid passes through the gas mixing passage 9 in this negative pressure state, gas that has passed through the gas suction chamber 8 connected to the outside air is mixed from the gas mixing passage 9.

Here, as shown in FIG. 2, the mixed gas 9a is mixed by the gas mixing passage 9 formed in the tangential direction with respect to the central axis of the main passage 5, such that a swirling flow 6a of the central axis of the main passage 5 in which the gas and the liquid are mixed can be obtained from rectified liquid in the central axis direction of the main passage 5. Note that the gas is sheared by such swirling, but at this stage, bubbles with a large particle size remain and are not uniform.

Further, by forming the gas suction chamber 8 in an outer ring of the main passage 5, the gas mixing passage 9 formed in the tangential direction with respect to the central axis of the main passage 5 can be connected to the main passage 5 from any direction, and the gas inlet 7 connecting the gas suction chamber 8 and the outside air can be formed at one place.

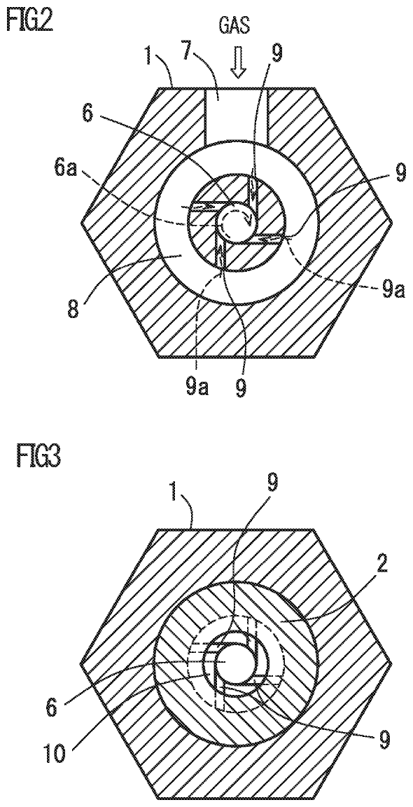

As shown in FIGS. 3 and 4, by forming the gas mixing passage 9 in a groove shape on the joint surface of the first member 1 with respect to the second member 2, and forming the main passage 5 on the end surface of the second member 2 larger than the main passage 5 on the end surface of the first member 1, the gas mixing passage 9 provided in the tangential direction with respect to the central axis of the main passage 5 can be connected to a tangent position of a maximum diameter of a circular main passage 5 on the end surface of the second member 2. Further, the connection end side of the gas mixing passage 9 with respect to the throttle portion 6 is opened to the conical portion 10.

The liquid flowing through the main passage 5 changes from a cross section of the throttle portion 6 to a cross section of an upstream side of the conical portion 10 larger than the cross section of the throttle portion 6 when passing through the joint surface of the first member 1 and the second member 2. At this time, inside the main passage 5, a flow region R in which the liquid is difficult to flow is formed in an circumferential portion of the end surface of the conical portion 10, that is, in the vicinity of the tangential portion connecting the gas mixing passage 9 on the end surface of the second member 2 (see FIG. 4). By allowing the gas to flow into the flow region R, the gas can be mixed into the liquid along the flow of the liquid flowing through the main passage 5.

In this way, the gas can be mixed from a direction in which the tangential direction to the central axis of the main passage 5 and the direction along the flow of the liquid flowing through the main passage 5 are combined, such that the rectified liquid can be turned into the swirling flow 6a around the center axis of the main passage 5 in which the gas and the liquid are efficiently mixed.

Further, by forming the gas mixing passage 9 into the groove shape on the joint surface of the first member 1, it is possible to perform processing from the liquid flow axis direction when producing the member. Therefore, an annular gas suction chamber 8 and the gas mixing passage 9 formed on the outside of the main passage 5 can be manufactured with an integral member, which leads to cost reduction.

As shown in FIGS. 5 and 6, the second member 2 is formed with a conical portion 10 and a plurality of (four in FIG. 6) protruding portions 11 that protrude from an inner wall forming the conical portion 10. In the second member 2, the conical portion 10 is formed at a cone angle 101 with respect to the central axis of the main passage 5 so that a cross section of the main passage 5 becomes larger as the conical portion 10 proceeds in the flow direction. Therefore, the gas-liquid mixed swirling flow 6a from the throttle portion 8 is accelerated by the centrifugal force as it advances in the flow direction along the inner wall of the conical portion 10, and becomes a swirling flow 10a (see FIG. 6). Note that in the present example, the conical portion 10 and the protruding portion 11 formed by wire electric discharge machining are illustrated.

The plurality of protruding portions 11 are formed in a plate shape extending in the central axis direction of the main passage 5. Each of the protruding portions 11 extends over substantially an entire length of the conical portion 10 in the longitudinal section along the central axis of the main passage 5 of the second member 2. In addition, an inclination angle of a protruding end edge of each protruding portion 11 with respect to the central axis of the main passage 5 is set to a value smaller than the inclination angle of the inner wall of the conical portion 10 with respect to the central axis of the main passage 5. In addition, each protruding portion 11 is formed so that a protruding height from the inner wall of the conical portion 10 gradually increases toward the downstream side in a longitudinal direction.

The plurality of protruding portions 11 are arranged at equal pitch angular intervals around the central axis of the conical portion 10. An angle 102 formed by protruding end edges of a pair of protruding portions 11 facing each other among the plurality of protruding portions 11 is set to a value smaller than a cone angle 101 formed by the conical portion 10. Since the protruding portion 11 is low in an upstream portion of the conical portion 10 before acceleration, the main swirling flow 6a is received downstream without resistance and accelerated, and since the protruding portion 11 is high in the downstream portion of the conical portion 10 of the further accelerated swirling flow 10a, bubble crushing due to intense collision and the sub swirling flow 11a are generated, and the bubble crushing is performed more intensely by colliding with the main swirling flow 10a.

Here, in the present example, the protruding portion 11 whose protruding height from the inner wall of the conical portion 10 gradually increases toward the downstream side is illustrated, but is not limited thereto. For example, as shown in FIG. 7, the protruding portion 11 may include a gradually changing portion 18a in which the protruding height from the inner wall of the conical portion 10 gradually increases toward the downstream side, and a constant height portion 18b which is continuous with the downstream side of the gradually changing portion 18a and has the same protruding height. In this case, a starting point (upstream end) of the constant height portion 18b is different from the starting point (upstream end) of the inner wall of the conical portion 10. Note that the angle and the starting point for forming the protruding portion 11 and the number of protruding portions can be set according to a liquid flow rate and an air amount.

Further, in the present example, since the protruding portion 11 has a corner on a protruding end side, fine bubbles can be generated by cavitation of the gas-liquid passing through the corner. However, for example, as shown in FIG. 8, the protruding portion 11 may be formed in an arc shape having no corner on the protruding end side. In this case, a collision sound between the protruding portion 11 and the swirling flow 10a is suppressed.

As shown in FIGS. 9 and 10, the third member 3 is formed in a bottomed cylindrical shape. The third member 3 forms a discharge chamber 13 with the second member 2. Further, on a bottom surface side of the third member 3, a long-hole shaped discharge port 14 is formed along a circumference of the central axis of the main passage 5. A plurality of (three in FIG. 9) discharge ports 14 are arranged at equal pitch angle intervals around the central axis of the main passage 5. Thus, by providing the long-hole shaped discharge port 14 along the circumference of the central axis of the main passage 5 without providing the discharge port on the center side of the main passage 5, the central flow 13a, which is a flow around the central axis of the main passage 5 and does not become the swirling flow 10a, is collided with the main swirling flow 10a accelerated along the inner wall of the conical portion 10 in the discharge chamber 13, thereby making it possible to discharge the gas-liquid of more uniform and fine bubbles from the discharge port 14.

Next, gas-liquid mixing tests according to an experimental example and a comparative example will be described.

In the gas-liquid mixing test of the experimental example, the gas-liquid mixing device A according to the example was employed, and the discharge flow discharged from the discharge port 14 was observed. On the other hand, in the gas-liquid mixing test of the comparative example, the gas-liquid mixing device A according to the example that did not include the protruding portion 11 was employed, and the discharge flow discharged from the discharge port 14 was observed. As a result, in the gas-liquid mixing test of the experimental example, it was confirmed that the discharge flow contains uniform and fine bubbles of 0.1 mm or less. In contrast, in the gas-liquid mixing test of the comparative example, it was confirmed that bubbles of about 1 mm, in addition to the fine bubbles of 0.1 mm or less, were contained in the discharge flow.

In the present invention, the present invention is not limited to the above example, and various modifications can be made within the scope of the present invention depending on the purpose and application. That is, in the above-described example, the form in which the protruding portion 11 is raised on the inner wall of the conical portion 10 is illustrated, but the present invention is not limited thereto. For example, as shown in FIG. 11, the protruding portion 11 may be provided on the inner wall forming the main passage 5 downstream of the conical portion 10 (specifically, on the inner wall forming the discharge chamber 13). In this case, far example, the protruding portion 11 may be provided on the inner wall of the main passage 5 over the conical portion 10 and the downstream side of the conical portion 10.

Further, in the above-described example, the protruding portion 11 including the linear protruding edge whose protruding height from the inner wall of the conical portion 10 increases toward the downstream side is illustrated, but is not limited thereto. For example, the protruding portion 11 may have a stepped or curved protruding edge whose protruding height from the inner wall of the conical portion 10 increases toward the downstream side. Furthermore, for example, the protruding portion 11 having a constant protruding height from the inner wall of the conical portion 10 may be used.

Furthermore, in the above-described example, the protruding portion 11 extending over the entire length of the inner wall of the conical portion 10 in the longitudinal section along the central axis of the main passage 5 is illustrated, but is not limited thereto. For example, the protruding portion 11 may extend along a part of the entire length of the inner wall of the conical portion 10 in the longitudinal section along the central axis of the main passage 5.

The gas-liquid mixing device according to the present invention is not limited to the configuration of the above-described example, and the configuration may be changed as appropriate without departing from the essence of the claimed invention.

The present invention is widely used as a technology related to gas-liquid mixing used in various fields such as aquaculture, purification, and cleaning, for example.

What is claimed is:

1. A gas-liquid mixing device having a venturi structure in which a throttle portion and a conical portion being continuous with a downstream side of the throttle portion and increasing in diameter toward the downstream side are provided in a main passage through which a liquid passes, the gas-liquid mixing device comprising:
a gas mixing passage for taking in gas from a tangential direction with respect to the main passage having a circular cross section; and
a protruding portion provided on a downstream side of the gas mixing passage of an inner wall forming the main passage and extending in a central axis direction of the main passage.

2. The gas-liquid mixing device according to claim 1, wherein the protruding portion is provided on an inner wall forming the conical portion, and is formed such that a protruding height from the inner wall increases toward the downstream side.

3. The gas-liquid mixing device according to claim 1, wherein the protruding portion is provided on a downstream side of the conical portion of the inner wall forming the main passage.

4. The gas-liquid mixing device according to claim 1, wherein
the main passage is formed across a first member and a second member joined to the first member,
the gas mixing passage is formed in a groove shape on a joint surface side of the first member with respect to the second member, and
an inner diameter of the main passage of the second member is larger than an inner diameter of the main passage of the first member on an upstream side, in a joint surface of the first member and the second member.

5. The gas-liquid mixing device according to claim 1, further comprising a long-hole shaped discharge port along a circumference of a central axis of the main passage.
